(19) United States
(12) Patent Application Publication
(10) Pub. No.: US 2017/0147593 A1
(43) Pub. Date: May 25, 2017

(54) CONTACT MANAGING METHOD AND APPARATUS, AND STORAGE MEDIUM

(71) Applicant: XIAOMI INC., Beijing (CN)

(72) Inventors: Kun MA, Beijing (CN); Dalong SHI, Beijing (CN); Jinbin LIN, Beijing (CN)

(73) Assignee: XIAOMI INC., Beijing (CN)

(21) Appl. No.: 15/262,677

(22) Filed: Sep. 12, 2016

(30) Foreign Application Priority Data
Nov. 20, 2015 (CN) 201510812863.3

(51) Int. Cl. G06F 17/30

(52) U.S. Cl. CPC G06F 17/30117; G06F 17/30303; H04L 61/1594

(57) ABSTRACT

A method, an apparatus, and a storage medium are provided for managing contacts. In the method, the apparatus acquires contact information of contacts in a contact book, where the contact information includes information on viewing of social information of the contacts. The apparatus determines at least one contact whose contact information meets a prescribed condition as at least one contact to be deleted. The apparatus then displays the determined contact to be deleted.

### CROSS-REFERENCE TO RELATED APPLICATION

This application is based on and claims priority of the Chinese Patent Application No. 201510812863.3, filed on Nov. 20, 2015, which is incorporated herein by reference in its entirety.

### TECHNICAL FIELD

The present disclosure is related to telecommunication technologies, and more particularly, to a contact managing method and apparatus, and a storage medium.

### BACKGROUND

Continuous development of telecommunication technologies enables more people to contact their friends using telecommunication tools, such as instant-messaging tools, short message applications and phone call applications. As time passes by, the number of contacts stored in a contact book of a telecommunication tool may increase. Some of the contacts may be rarely contacted, and the time for adding a certain contact may be forgotten by a user himself/herself. The increasing number of contacts stored in a contact book may be bothering for the user.

### SUMMARY

According to a first aspect of the present disclosure, there is provided a contact managing method. In the method, an apparatus acquires contact information of contacts in a contact book, where the contact information include information on viewing of social information of the contacts. The apparatus determines at least one contact whose contact information meets a prescribed condition as at least one contact to be deleted. The apparatus displays the at least one contact to be deleted.

According to a second aspect of the present disclosure, there is provided a contact managing apparatus, which includes: an acquiring module, a determining module, and a displaying module. The acquiring module is configured to acquire contact information of contacts in a contact book, the contact information including information on viewing of social information of the contacts. The determining module is configured to determine whether there is at least one contact whose contact information acquired by the acquiring module meets a prescribed condition and select the at least one contact as contact to be deleted. The displaying module is configured to display the contact to be deleted determined by the determining module.

According to a third aspect of the present disclosure, there is provided a contact managing apparatus that includes: a processor and a memory storing instructions executable by the processor. The processor is configured to: acquire contact information of contacts in a contact book, the contact information including information on viewing of social information of the contacts; determine whether there is at least one contact whose contact information meets a prescribed condition and select the at least one contact as contact to be deleted; and display the contact to be deleted.

According to a fourth aspect of the present disclosure, there is provided a non-transitory computer-readable storage medium having stored therein instructions that, when executed by a processor of a mobile terminal, causes the mobile terminal to perform following acts. The acts include: acquiring contact information of contacts in a contact book, the contact information including information on viewing of social information of the contacts; determining at least one contact whose contact information meets a prescribed condition as at least one contact to be deleted; and displaying the at least one contact as contact to be deleted.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is flow chart showing a contact managing method according to one or more embodiments;

FIG. 2 is a flow chart showing a contact managing method according to one or more embodiments;

FIG. 3 is a schematic diagram showing how to display determined contacts to be deleted on a cell phone interface according to one or more embodiments;

FIG. 4 is a flow chart showing a contact managing method according to one or more embodiments;

FIG. 5 is a block diagram showing a contact managing apparatus according to one or more embodiments;

FIG. 6 is a block diagram showing a contact managing apparatus according to one or more embodiments;

FIG. 7 is a block diagram showing a contact managing apparatus according to one or more embodiments; and

FIG. 8 is a block diagram showing a contact managing apparatus according to one or more embodiments.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

Reference will now be made in detail to embodiments, examples of which are illustrated in the accompanying drawings. The following description refers to the accompanying drawings in which the same numbers in different drawings represent the same or similar elements unless otherwise presented. The embodiments set forth in the following description of embodiments do not represent all embodiments consistent with the disclosure. Instead, they are merely examples of apparatuses and methods consistent with aspects related to the disclosure as recited in the appended claims.

The technical solutions provided by the embodiments of the present disclosure relate to a terminal device, which may be a cell phone, a tablet computer, a laptop computer or the like. The terminal device manages contacts in a contact book, which is stored in the terminal device or in an application installed in the terminal device.

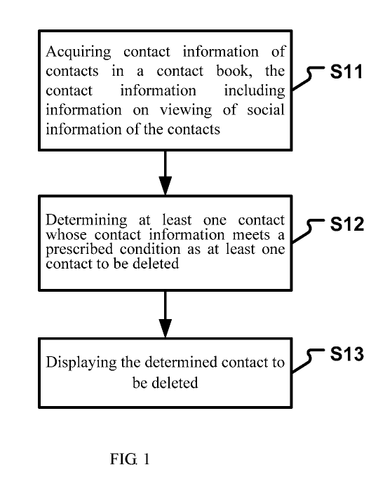

FIG. 1 is a flow chart showing a contact managing method according to one or more embodiments. As shown in FIG. 1, the contact managing method may be implemented in a terminal device. The method may include steps S11-S13.

In step S11, contact information of contacts in a contact book is acquired, where the contact information includes information on viewing of social information of the contacts. Here, the information on viewing of social information may include statistic information about the interaction between the user and the one or more contacts.

The contact information may include one or more of the following kinds of contact information: a time when a contact is added, a time when the contact is contacted and/or the number of times the contact is contacted, a time when a profile of the contact is viewed and/or the number of times the profile of the contact is viewed, a time when a personal space of the contact is viewed and/or the number of times the personal space of the contact is viewed, a time when information issued by the contact is read and/or the number of times the information issued by the contact is read, and a time when the contact’ comments are responded to and/or the number of times the contact's comments are responded to. The time when the profile of the contact is viewed and/or the number of times the profile of the contact is viewed, the time when the personal space of the contact is viewed and/or the number of times the personal space of the contact is viewed, the time when information issued by the contact is read and/or the number of times the information issued by the contact is read, and the time when the contact’ comments are responded to and/or the number of times the contact's comments are responded to belong to the information on viewing of the social information of the contact.

In step S12, at least one contact whose contact information meets a prescribed condition is determined as at least one contact to be deleted. The terminal device may determine whether there is at least one contact whose contact information meets a prescribed condition. When the apparatus determines that there exists at least one contact whose contact information meets the prescribed condition, the terminal device may select the at least one contact as contact to be deleted.

In step S13, the determined contact to be deleted is displayed. The terminal device may display the contact to be deleted on its display screen for the user to confirm whether to delete any of the displayed contact.

For example, a terminal device can determine, based on contact information of the contacts in the contact book and the prescribed condition, which ones of the contacts have contact information that meets the prescribed condition; and display the determined contacts to be deleted, wherein the contact information includes information on viewing of social information of the contacts. As a result, the terminal device can provide contacts to be deleted based on the information on viewing of the social information of the contacts, so that it is convenient for a user to manage the contacts in the contact book based on the information on viewing of the social information of the contacts.

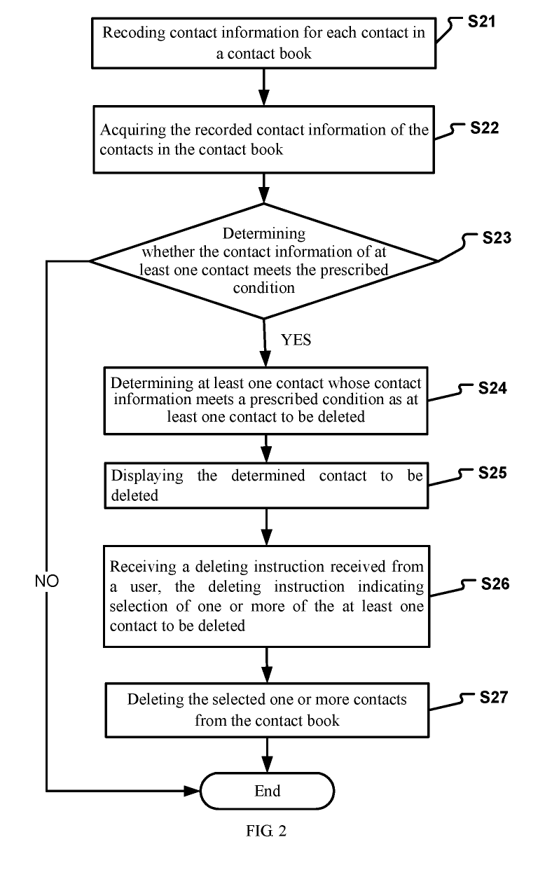

FIG. 2 is a flow chart showing a contact managing method according to one or more embodiments. As shown in FIG. 2, the contact managing method includes the followings steps, which may be implemented by the terminal device.

In step S21, contact information for each contact in the contact book is recorded.

The contact information may include one or more of: a time when the contact is added, a time when the contact is contacted and/or the number of times the contact is contacted, a time when a profile of the contact is viewed and/or the number of times the profile of the contact is viewed, a time when a personal space of the contact is viewed and/or the number of times the personal space of the contact is viewed, a time when information issued by the contact is read and/or the number of times the information issued by the contact is read, and a time when the contact's comments are responded to and/or the number of times the contact's comments are responded to.

In step S22, the recorded contact information of the contacts in the contact book is acquired.

In step S23, it is determined whether the contact information of each contact meets a prescribed condition. If yes, step S24 is performed; if no, the process ends.

The prescribed condition is a basis for determining whether a contact can be deleted. The prescribed condition may be designed by a user himself/herself according to his/her own needs, and may be loose or strict. An example of a loose prescribed condition may be that the most recent time when information issued by the contact was read is half a year ago; that is, if the information issued by the contact has not been read in the recent half a year, the contact is determined as a contact to be deleted. An example of a strict prescribed condition may be that the most recent time when information issued by the contact was read is one month ago and the most recent time when the contact responded to comments is one month ago; that is, only if the information issued by the contact has not been read in the recent month and the contact has not responded to comments in the recent month, the contact is determined as a contact to be deleted. Here, the loose prescribed condition and the strict prescribed condition are determined by a preset time period, which may be adjusted by the user to be a month, half a year, or any other time period. Alternatively or additionally, the loose prescribed condition and the strict prescribed condition may also be determined by a interaction frequency between the user and the contact. The interaction frequency may be once/month, twice/month, or any other frequency set by the user.

In the present disclosure, the prescribed condition may be set according to the needs of the user.

In step S24, the terminal device selects at least one contact whose contact information meets the prescribed condition as at least one contact to be deleted.

In step S25, the determined contact to be deleted is displayed.

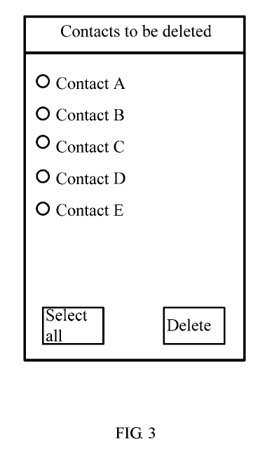

By way of example, FIG. 3 illustrates an interface of a mobile phone where the at least one determined contact to be deleted is displayed in a list.

In step S26, a deleting instruction is received from the user, the deleting instruction indicating selection of one or more of the displayed at least one contact to be deleted.

For example, the user may select a contact to be deleted by checking a check box in a list of contacts to be deleted shown in FIG. 3.

In step S27, the selected one or more contacts are deleted from the contact book.

Here, the contact information of contacts is recorded in advance, so that selection of contacts based on the recorded contact information can be performed. In addition, by displaying the selected contacts to the user, the user can conveniently select therefrom the contacts to be deleted. Therefore, the user can be provided with a function of deleting contacts by batch, and it is convenient for the user to manage contacts.

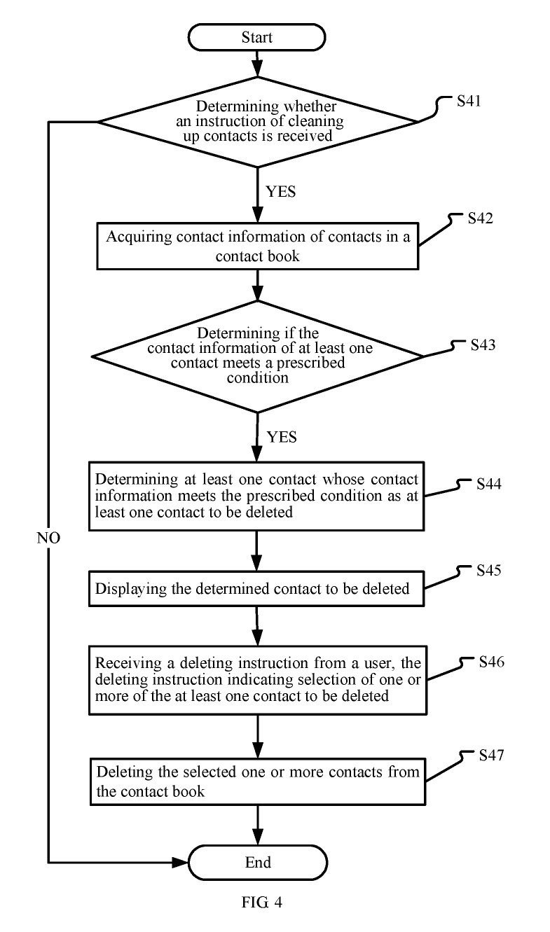

FIG. 4 is a flow chart showing a contact managing method according to one or more embodiments. As shown in FIG. 4, the contact managing method includes the followings steps.

In step S41, it is determined whether an instruction of cleaning up contacts is received. If yes, step S42 is performed; if no, the process ends.

In step S42, contact information of contacts in a contact book is acquired.

In step S43, it is determined whether the contact information of each contact meets the prescribed condition. If yes, step S44 is performed; if no, the process ends.

In step S44, at least one contact whose contact information meets the prescribed condition is determined as at least one contact to be deleted. The terminal device may select the at least one contact whose contact information meets the prescribed condition as at least one contact to be deleted.

In step S45, the determined contact to be deleted is displayed.

In step S46, a deleting instruction is received from a user, the deleting instruction indicating selection of one or more of at least one contact to be deleted.

In step S47, the selected one or more contacts are deleted from the contact book.

In this embodiment, the method may be initiated depending on whether the instruction of cleaning up contacts is received. The instruction of cleaning up contacts may be triggered by selecting a functional key disposed on a terminal device or on an application in the terminal device so that the user can manually start the function of cleaning up contacts.

Additionally or alternatively, the contact managing method may be performed regularly and automatically. For example, the application in the terminal device may automatically clean up contacts once every week or every 3 days, and display all the contacts to be deleted.

The followings are apparatus embodiments of the present disclosure, which may perform the method embodiments of the present disclosure.

FIG. 5 is a block diagram showing a contact managing apparatus according to one or more embodiments. The apparatus may be realized as a part of or all of an electronic device in the form of software, hardware or a combination thereof.

As shown in FIG. 5, the contact managing apparatus includes the following modules.

An acquiring module 51 is configured to acquire contact information of contacts in a contact book, the contact information including information on viewing of social information of the contacts.

The contact information may include one or more of the following kinds of contact information: a time when a contact is added, a time when the contact is contacted and/or the number of times the contact is contacted, a time when a profile of the contact is viewed and/or the number of times the profile of the contact is viewed, a time when a personal space of the contact is viewed and/or the number of times the personal space of the contact is viewed, a time when information issued by the contact is read and/or the number of times the information issued by the contact is read, and a time when the contact’ comments are responded to and/or the number of times the contact's comments are responded to. The time when the profile of the contact is viewed and/or the number of times the profile of the contact is viewed, the time when the personal space of the contact is viewed and/or the number of times the personal space of the contact is viewed, the time when information issued by the contact is read and/or the number of times the information issued by the contact is read, and the time when the contact’ comments are responded to and/or the number of times the contact's comments are responded to belong to the information on viewing of the social information of the contact.

A determining module 52 is configured to determine at least one contact whose contact information acquired by the acquiring module 51 meets a prescribed condition as at least one contact to be deleted.

The prescribed condition is a basis for determining whether a contact can be deleted, may be designed by a user himself/herself according to his/her own needs, and may be loose or strict. An example of a loose prescribed condition may be that the most recent time when information issued by the contact was read is half a year ago; that is, if the information issued by the contact has not been read in the recent half year, the contact is determined as a contact to be deleted. An example of a strict prescribed condition may be that the most recent time when information issued by the contact was read is one month ago and the most recent time when the contact responded to comments is one month ago; that is, only if the information issued by the contact has not been read in the recent month and the contact has not responded to comments in the recent month, the contact is determined as a contact to be deleted.

A displaying module 53 is configured to display the contact to be deleted determined by the determining module 52.

In one or more embodiments, a terminal device can determine, based on contact information of the contacts in the contact book and the prescribed condition, which ones of the contacts have contact information that meets the prescribed condition; and display the determined contacts to be deleted, wherein the contact information includes information on viewing of social information of the contacts. As a result, the terminal device can provide contacts to be deleted based on the information on viewing of the social information of the contacts, so that it is convenient for a user to manage the contacts in the contact book based on the information on viewing of the social information of the contacts.

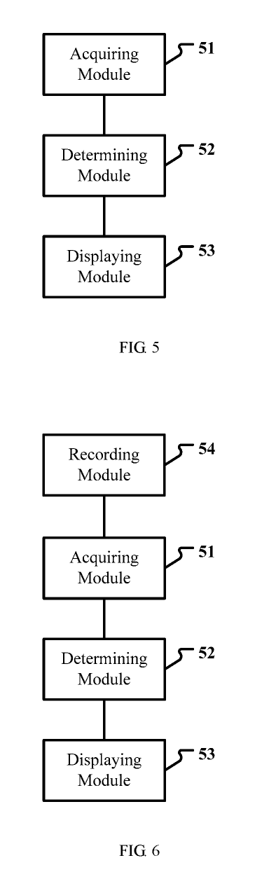

FIG. 6 is a block diagram showing a contact managing apparatus according to one or more embodiments. As shown in FIG. 6, the apparatus further includes a recording module 54.

The recording module 54 is configured to, before the contact information of the contacts is acquired by the acquiring module 51, record one or more of the following kinds contact information for each contact: a time when the contact is added, a time when the contact is contacted and/or the number of times the contact is contacted, a time when a profile of the contact is viewed and/or the number of times the profile of the contact is viewed, a time when a personal space of the contact is viewed and/or the number of times the personal space of the contact is viewed, a time when information issued by the contact is read and/or the number of times the information issued by the contact is read, and a time when the contact responds to comments and/or the number of times the contact responds to the comments.

The acquiring module 51 is configured to acquire contact information of the contacts in the contact book from the contact information recorded by the recording module 54.

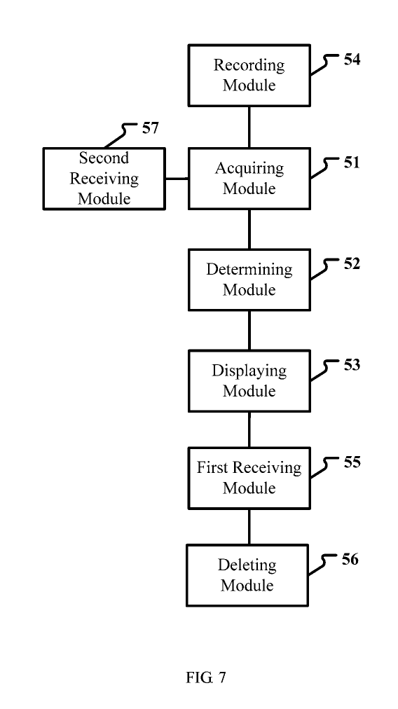

FIG. 7 is a block diagram showing a contact managing apparatus according to one or more embodiments. As shown in FIG. 7, the apparatus further includes a first receiving module 55 and a deleting module 56.

The first receiving module 55 is configured to receive a deleting instruction from a user, the deleting instruction indicating selection of one or more of the at least one contact to be deleted that is displayed by the displaying module 53.

The deleting module 56 is configured to delete from the contact book the one or more contacts which are selected according to the deleting instruction received by the first receiving module 55.

In one or more embodiments, the apparatus further includes a second receiving module 57 configured to receive an instruction of cleaning up contacts before the contact information of the contacts in the contact book is acquired by the acquiring module 51.

Here, the cleaning up of contacts may be initiated depending on whether the instruction of cleaning up contacts is received. The instruction of cleaning up contacts may be triggered by selecting a functional key disposed on a terminal device or on an application in the terminal device so that the user can manually start the function of cleaning up contacts.

In one or more embodiments, the acquiring module 51 is configured to acquire the contact information of the contacts in the contact book at every prescribed time interval. For example, the application in the terminal device may automatically clean up contacts once every week or every 3 days, and display all the contacts to be deleted.

The present disclosure further provides a contact managing apparatus, comprising: a processor; and a memory storing instructions executable by the processor. The processor is configured to: acquire contact information of contacts in a contact book, the contact information including information on viewing of social information of the contacts; determine at least one contact whose contact information meets a prescribed condition as at least one contact to be deleted; and display the determined contact to be deleted.

With respect to the apparatuses in the above embodiments, the specific manners for performing operations for individual modules therein have been described in detail in the embodiments regarding the related methods, and will not be elaborated herein.

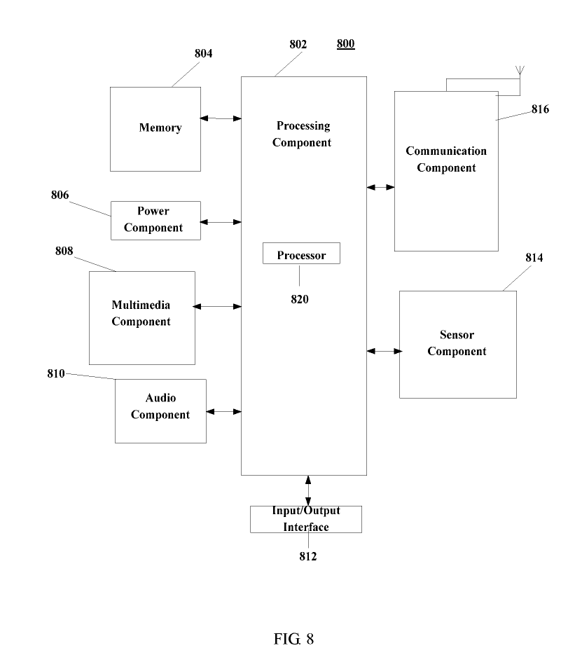

FIG. 8 is a block diagram showing a contact managing apparatus 800 according to still another embodiment. For example, the apparatus 800 may be a mobile phone, a computer, a digital broadcast terminal, a messaging device, a gaming console, a tablet, a medical device, exercise equipment, a personal digital assistant or the like.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G, or 3G, or a combination thereof. In one embodiment, the communication component 816 receives a broadcast signal or broadcast associated information from an external broadcast management system via a broadcast channel. In one embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 800 may be implemented with one or more circuitries which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus 800 may perform the above described methods using the one or more circuitries.

In an embodiment, there is also provided a non-transitory computer readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

There is provided a non-transitory computer-readable storage medium having stored therein instructions that, when executed by a processor of a mobile terminal, cause the mobile terminal to perform a contact managing method, the method comprising: acquiring contact information of contacts in a contact book, the contact information including information on viewing of social information of the contacts; determining at least one contact whose contact information meets a prescribed condition as at least one contact to be deleted; and displaying the determined contact to be deleted.

Optionally, before acquiring the contact information of the contacts in the contact book, the method further includes recording one or more of the following kinds of contact information for each contact: a time when the contact is added, a time when the contact is contacted and/or the number of times the contact is contacted, a time when a profile of the contact is viewed and/or the number of times the profile of the contact is viewed, a time when a personal space of the contact is viewed and/or the number of times the personal space of the contact is viewed, a time when information issued by the contact is read and/or the number of times the information issued by the contact is read, and a time when the contact's comments are responded to and/or the number of times the contact's comments are responded to. Acquiring the contact information of the contacts in the contact book includes: acquiring contact information of the contacts in the contact book from the recorded contact information.

Optionally, after displaying the determined contact to be deleted, the method further includes: receiving a deleting instruction from a user, the deleting instruction indicating selection of one or more of the at least one contact to be deleted; and deleting the one or more contacts from the contact book.

Optionally, before acquiring the contact information of the contacts in the contact book, the method further includes: receiving an instruction of cleaning up contacts.

Optionally, said acquiring the contact information of the contacts in the contact book includes: acquiring the contact information of the contacts in the contact book at every prescribed time interval.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for managing contacts, comprising:
acquiring contact information of contacts in a contact book, the contact information including information on viewing of social information of the contacts;
determining at least one contact whose contact information meets a prescribed condition as at least one contact to be deleted; and
displaying the determined contact to be deleted.

2. The method of claim 1, wherein before acquiring the contact information of the contacts in the contact book, the method further comprises recording at least one of the following kinds of contact information for each contact: a time when the contact is added, a time when the contact is contacted, the number of times the contact is contacted, and the information on viewing of social information of the contact, wherein the information on viewing of the social information of the contact comprises at least one of: a time when a profile of the contact is viewed, a time when a personal space of the contact is viewed, a time when information issued by the contact is read, and a time when the contact responds to comments; and
wherein acquiring the contact information of the contacts in the contact book comprises:
acquiring contact information of the contacts in the contact book from the recorded contact information.

3. The method of claim 1, wherein before acquiring the contact information of the contacts in the contact book, the method further comprises recording at least one of the following kinds of contact information for each contact: a time when the contact is added, a time when the contact is contacted, the number of times the contact is contacted, and the information on viewing of social information of the contact, wherein the information on viewing of the social information of the contact comprises at least one of: a first number of times a profile of the contact is viewed, a second number of times the personal space of the contact is viewed, a third number of times the information issued by the contact is read, and a fourth number of times the contact responds to the comments; and
wherein acquiring the contact information of the contacts in the contact book comprises:
acquiring contact information of the contacts in the contact book from the recorded contact information.

4. The method of claim 1, wherein after displaying the determined contact to be deleted, the method further comprises:
receiving a deleting instruction that indicates selection of one or more contacts of the at least one contact to be deleted; and
deleting the one or more contacts from the contact book.

5. The method of claim 1, wherein before acquiring the contact information of the contacts in the contact book, the method further comprises:
receiving an instruction of cleaning up contacts.

6. The method of claim 1, wherein said acquiring the contact information of the contacts in the contact book comprises:
acquiring the contact information of the contacts in the contact book at every prescribed time interval.

7. A contact managing apparatus, comprising:
a processor; and
a memory storing instructions executable by the processor,
wherein the processor is configured to:
acquire contact information of contacts in a contact book, the contact information including information on viewing of social information of the contacts;
determine whether there is at least one contact whose contact information meets a prescribed condition and select the at least one contact as contact to be deleted; and
display the contact to be deleted.

8. The apparatus of claim 7, wherein the processor is further configured to:
before acquiring the contact information of the contacts in the contact book, record at least one of the following kinds of contact information for each contact: a time when the contact is added, a time when the contact is contacted, the number of times the contact is contacted, and the information on viewing of social information of the contact, wherein the information on viewing of the social information of the contact comprises at least one of: a time when a profile of the contact is viewed, a time when a personal space of the contact is viewed, a time when information issued by the contact is read, and a time when the contact responds to comments; and
wherein acquiring the contact information of the contacts in the contact book comprises:
acquiring contact information of the contacts in the contact book from the recorded contact information.

9. The apparatus of claim 7, wherein the processor is further configured to:
before acquiring the contact information of the contacts in the contact book, record at least one of the following kinds of contact information for each contact: a time when the contact is added, a time when the contact is contacted, the number of times the contact is contacted, and the information on viewing of social information of the contact, wherein the information on viewing of the social information of the contact comprises at least one of: a first number of times a profile of the contact is viewed, a second number of times the personal space of the contact is viewed, a third number of times the information issued by the contact is read, and a fourth number of times the contact responds to the comments; and
wherein acquiring the contact information of the contacts in the contact book comprises:
acquiring contact information of the contacts in the contact book from the recorded contact information.

10. The apparatus of claim 7, wherein the processor is further configured to:
after displaying the determined contact to be deleted, receive a deleting instruction that indicates selection of one or more contacts of the at least one contact to be deleted; and
delete the one or more contacts from the contact book.

11. The apparatus of claim 7, wherein the processor is further configured to: before acquiring the contact information of the contacts in the contact book, receive an instruction of cleaning up contacts.

12. The apparatus of claim 7, wherein the processor is further configured to: acquire the contact information of the contacts in the contact book at every prescribed time interval.

13. A non-transitory computer-readable storage medium having stored therein instructions that, when executed by a processor of a mobile terminal, causes the mobile terminal to perform acts comprising:
acquiring contact information of contacts in a contact book, the contact information including information on viewing of social information of the contacts; determining at least one contact whose contact information meets a prescribed condition as at least one contact to be deleted;
and displaying the determined contact to be deleted.

14. The storage medium of claim 13, wherein before acquiring the contact information of the contacts in the contact book, the acts further comprise recording at least one of the following kinds of contact information for each contact: a time when the contact is added, a time when the contact is contacted, and the number of times the contact is contacted, and information on viewing of social information of the contact, wherein
the information on viewing of the social information of the contact comprises at least one of: a time when a profile of the contact is viewed, a time when a personal space of the contact is viewed, a time when information issued by the contact is read, and a time when the contact responds to comments; and
wherein acquiring the contact information of the contacts in the contact book comprises:
acquiring contact information of the contacts in the contact book from the recorded contact information.

15. The storage medium of claim 13, wherein before acquiring the contact information of the contacts in the contact book, the acts further comprise recording at least one of the following kinds of contact information for each contact: a time when the contact is added, a time when the contact is contacted, and the number of times the contact is contacted, and information on viewing of social information of the contact, wherein
the information on viewing of the social information of the contact comprises at least one of: a first number of times a profile of the contact is viewed, a second number of times the personal space of the contact is viewed, a third number of times the information issued by the contact is read, and a fourth number of times the contact responds to the comments; and
wherein acquiring the contact information of the contacts in the contact book comprises:
acquiring contact information of the contacts in the contact book from the recorded contact information.

16. The storage medium of claim 13, wherein after displaying the determined contact to be deleted, the acts further comprise:
receiving a deleting instruction that indicates selection of one or more contacts of the at least one contact to be deleted; and
deleting the one or more contacts from the contact book.

17. The storage medium of claim 13, wherein before acquiring the contact information of the contacts in the contact book, the acts further comprise:
receiving an instruction of cleaning up contacts.

18. The storage medium of claim 13, wherein said acquiring the contact information of the contacts in the contact book comprises: acquiring the contact information of the contacts in the contact book at every prescribed time interval.
